(19) United States
(12) Patent Application Publication
(10) Pub. No.: US 2025/0081127 A1
(43) Pub. Date: Mar. 6, 2025

(54) APPARATUS, METHOD AND COMPUTER PROGRAM

(71) Applicant: Nokia Technologies Oy, Espoo (FI)

(72) Inventors: Johannes HARREBEK, Aalborg (DK); Benny VEJLGAARD, Gistrup (DK); Nuno Manuel KIILERICH PRATAS, Aalborg (DK); Oana-Elena BARBU, Aalborg (DK); Simon SVENDSEN, Aalborg (DK)

(73) Assignee: Nokia Technologies Oy, Espoo (FI)

(21) Appl. No.: 18/817,361

(22) Filed: Aug. 28, 2024

(30) Foreign Application Priority Data
Sep. 1, 2023 (GB) 2313379.6

(51) Int. Cl. H04W 52/38; G06K 7/10; H04W 52/24

(52) U.S. Cl. CPC H04W 52/383; G06K 7/10366; H04W 52/241; H04W 52/242

(57) ABSTRACT

There is provided an activator device comprising means for determining a first transmit power for a signal from the activator device to arrive at at least one reader device, determining a second transmit power for a response signal from a tag device to the at least one reader device based at least on the first transmit power and providing, by the activator device to the tag device, a configuration of the second transmit power for the response signal from the tag device to the at least one reader device.

### FIELD

The present application relates to a method, apparatus, system and computer program and in particular but not exclusively to an ambient IoT power control procedure.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, video, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). Some wireless systems can be divided into cells, and are therefore often referred to as cellular systems.

A user can access the communication system by means of an appropriate communication device or terminal. A communication device of a user may be referred to as user equipment (UE) or user device. A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. One example of a communications system is Universal Mobile Telecommunications System (UMTS) Terrestrial Radio Access Network (UTRAN) (3G radio). Other examples of communication systems are the long-term evolution (LTE) of the Universal Mobile Telecommunications System (UMTS) radio-access technology and so-called 5G or New Radio (NR) networks. NR is being standardized by the 3rd Generation Partnership Project (3GPP). Other examples of communication systems include 5G-Advanced (NR Rel-18 and beyond) and 6G.

### SUMMARY

In a first aspect there is provided an activator device comprising means for determining a first transmit power for a signal from the activator device to arrive at at least one reader device, determining a second transmit power for a response signal from a tag device to the at least one reader device based at least on the first transmit power and providing, by the activator device to the tag device, a configuration of the second transmit power for the response signal from the tag device to the at least one reader device.

The configuration of the second transmit power may be included in an activation signal provided by the activator device to the tag device at a third transmit power.

The apparatus may comprise means for receiving an indication of transmit power information relating to the activation signal and updating the third transmit power based on the transmit power information relating to the activation signal.

The apparatus may comprise means for receiving the response signal at the activator device and updating the third transmit power based on the received response signal.

Determining the first transmit power may comprise performing an open loop power control procedure between the activator device and the at least one reader device or performing a sidelink ranging procedure between the activator device and the at least one reader device or is based on a position of the activator device and the at least one reader device.

The first transmit power may be further determined based on at least one of the following: a reader signal to noise requirement difference or an antenna gain difference between a link between the activator device and the reader device and a link between the tag device and the reader device.

The second transmit power may be equal to the first transmit power.

The second transmit power may comprise the first transmit power and an offset value.

The offset value may be determined based on an estimated pathloss between the activator device and the tag device.

The at least one reader device may comprise a network node.

The apparatus may comprise means for receiving an indication from the at least one reader device of a transmit power adjustment value; and determining the second transmit power may be further based on the transmit power adjustment value.

The apparatus may comprise means for receiving the indication of the transmit power adjustment value via a network node or a sidelink connection.

In a second aspect there is provided a reader device comprising means for receiving, at the reader device, a response signal from a tag device with a given transmit power, determining signal conditions between the tag device and the reader device based on the response signal, determining a transmit power adjustment value based on signal conditions between a tag device and the reader device and providing an indication of the determined transmit power adjustment value to an activator device which provides an activation signal to the tag device.

The signal conditions may comprise at least one of the following: receive signal quality or signal to noise ratio.

The apparatus may comprise means for providing the indication of the determined transmit power adjustment value to the activator device via a network node or a sidelink connection.

The response signal may comprise transmit power information relating to the activation signal and the apparatus may comprise means for providing an indication of the transmit power information relating to the activation signal to the activator device.

In a third aspect there is provided a tag device comprising means for receiving, at the tag device from an activator device, a configuration of a transmit power for a response signal from the tag device to at least one reader device and providing the response signal from the tag device to the at least one reader device at a transmit power determined based on the configuration.

The configuration of the transmit power may be included in an activation signal provided by the activator device to the tag device.

The response signal may comprise transmit power information relating to the activation signal.

In a fourth aspect there is provided a method comprising, at an activator device, determining a first transmit power for a signal from the activator device to arrive at at least one reader device, determining a second transmit power for a response signal from a tag device to the at least one reader device based at least on the first transmit power and providing, by the activator device to the tag device, a configuration of the second transmit power.

The configuration of the second transmit power may be included in an activation signal provided by the activator device to the tag device at a third transmit power.

The method may comprise receiving an indication of transmit power information relating to the activation signal and updating the third transmit power based on the transmit power information relating to the activation signal.

The method may comprise receiving the response signal at the activator device and updating the third transmit power based on the received response signal.

Determining the first transmit power may comprise performing an open loop power control procedure between the activator device and the at least one reader device or performing a sidelink ranging procedure between the activator device and the at least one reader device or is based on a position of the activator device and the at least one reader device.

The first transmit power may be further determined based on at least one of the following: a reader signal to noise requirement difference or an antenna gain difference between a link between the activator device and the reader device and a link between the tag device and the reader device.

The second transmit power may be equal to the first transmit power.

The second transmit power may comprise the first transmit power and an offset value.

The offset value may be determined based on an estimated pathloss between the activator device and the tag device.

The at least one reader device may comprise a network node.

The method may comprise receiving an indication from the at least one reader device of a transmit power adjustment value; and the second transmit power may be further based on the transmit power adjustment value.

The method may comprise receiving the indication of the transmit power adjustment value via a network node or a sidelink connection.

In a fifth aspect there is provided a method comprising, at a reader device, receiving, at the reader device, a response signal from a tag device with a given transmit power, determining signal conditions between the tag device and the reader device based on the response signal, determining a transmit power adjustment value based on the determined signal conditions between the tag device and the reader device and providing an indication of the determined transmit power adjustment value to an activator device which provides an activation signal to the tag device.

The signal conditions may comprise at least one of the following: receive signal quality or signal to noise ratio.

The method may comprise providing the indication of the determined transmit power adjustment value to the activator device via a network node or a sidelink connection.

The response signal may comprise transmit power information relating to the activation signal and the method may comprise providing an indication of the transmit power information relating to the activation signal to the activator device.

In a sixth aspect there is provided a method comprising, at a tag device, receiving, at the tag device from an activator device, a configuration of a transmit power for a response signal from the tag device to at least one reader device and providing the response signal from the tag device to the at least one reader device at a transmit power determined based on the configuration.

The configuration of the transmit power may be included in an activation signal provided by the activator device to the tag device.

The response signal may comprise transmit power information relating to the activation signal.

In a seventh aspect there is provided an apparatus comprising at least one processor, and at least one memory including computer program code, wherein the at least one memory and the computer program code are configured, with the at least one processor, to cause the apparatus at least to, at an activator device, determine a first transmit power for a signal from the activator device to arrive at at least one reader device, determine a second transmit power for a response signal from a tag device to the at least one reader device based at least on the first transmit power and provide, by the activator device to the tag device, a configuration of the second transmit power.

The configuration of the second transmit power may be included in an activation signal provided by the activator device to the tag device at a third transmit power.

The apparatus may be caused to receive an indication of transmit power information relating to the activation signal and update the third transmit power based on the transmit power information relating to the activation signal.

The apparatus may be caused to receive the response signal at the activator device and update the third transmit power based on the received response signal.

Determining the first transmit power may comprise performing an open loop power control procedure between the activator device and the at least one reader device or performing a sidelink ranging procedure between the activator device and the at least one reader device or is based on a position of the activator device and the at least one reader device.

The first transmit power may be further determined based on at least one of the following: a reader signal to noise requirement difference or an antenna gain difference between a link between the activator device and the reader device and a link between the tag device and the reader device.

The second transmit power may be equal to the first transmit power.

The second transmit power may comprise the first transmit power and an offset value.

The offset value may be determined based on an estimated pathloss between the activator device and the tag device.

The at least one reader device may comprise a network node.

The apparatus may be caused to receive an indication from the at least one reader device of a transmit power adjustment value and determining the second transmit power may be further based on the transmit power adjustment value.

The apparatus may be caused to receive the indication of the transmit power adjustment value via a network node or a sidelink connection.

In an eighth aspect there is provided an apparatus comprising at least one processor, and at least one memory including computer program code, wherein the at least one memory and the computer program code are configured, with the at least one processor, to cause the apparatus at least to, at a reader device, receive, at the reader device, a response signal from a tag device with a given transmit power, determine signal conditions between the tag device and the reader device based on the response signal, determine a transmit power adjustment value based on the determined signal conditions between the tag device and the reader device and provide an indication of the determined transmit power adjustment value to an activator device which provides an activation signal to the tag device.

The signal conditions may comprise at least one of the following: receive signal quality or signal to noise ratio.

The apparatus may be caused to provide the indication of the determined transmit power adjustment value to the activator device via a network node or a sidelink connection.

The response signal may comprise transmit power information relating to the activation signal and the apparatus may be caused to provide an indication of the transmit power information relating to the activation signal to the activator device.

In a ninth aspect there is provided an apparatus comprising at least one processor, and at least one memory including computer program code, wherein the at least one memory and the computer program code are configured, with the at least one processor, to cause the apparatus at least to, at a tag device, receive, at the tag device from an activator device, a configuration of a transmit power for a response signal from the tag device to at least one reader device and provide the response signal from the tag device to the at least one reader device at a transmit power determined based on the configuration.

The configuration of the transmit power may be included in an activation signal provided by the activator device to the tag device.

The response signal may comprise transmit power information relating to the activation signal.

In a tenth aspect there is provided a computer readable medium comprising instructions which, when executed by an apparatus, cause the apparatus to perform at least the following, at an activator device, determining a first transmit power for a signal from the activator device to arrive at at least one reader device, determining a second transmit power for a response signal from a tag device to the at least one reader device based at least on the first transmit power; and providing, by the activator device to the tag device, a configuration of the second transmit power.

The configuration of the second transmit power may be included in an activation signal provided by the activator device to the tag device at a third transmit power.

The apparatus may be caused to perform receiving an indication of transmit power information relating to the activation signal and updating the third transmit power based on the transmit power information relating to the activation signal.

The apparatus may be caused to perform receiving the response signal at the activator device and updating the third transmit power based on the received response signal.

Determining the first transmit power may comprise performing an open loop power control procedure between the activator device and the at least one reader device or performing a sidelink ranging procedure between the activator device and the at least one reader device or is based on a position of the activator device and the at least one reader device.

The first transmit power may be further determined based on at least one of the following: a reader signal to noise requirement difference or an antenna gain difference between a link between the activator device and the reader device and a link between the tag device and the reader device.

The second transmit power may be equal to the first transmit power.

The second transmit power may comprise the first transmit power and an offset value.

The offset value may be determined based on an estimated pathloss between the activator device and the tag device.

The at least one reader device may comprise a network node.

The apparatus may be caused to perform receiving an indication from the at least one reader device of a transmit power adjustment value and determining the second transmit power is further based on the transmit power adjustment value.

The apparatus may be caused to perform receiving the indication of the transmit power adjustment value via a network node or a sidelink connection.

In an eleventh aspect there is provided a computer readable medium comprising instructions which, when executed by an apparatus, cause the apparatus to perform at least the following, at a reader device, receiving, at the reader device, a response signal from a tag device with a given transmit power, determining signal conditions between the tag device and the reader device based on the response signal, determining a transmit power adjustment value based on the determined signal conditions between the tag device and the reader device and providing an indication of the determined transmit power adjustment value to an activator device which provides an activation signal to the tag device.

The signal conditions may comprise at least one of the following: receive signal quality or signal to noise ratio.

The apparatus may be caused to perform providing the indication of the determined transmit power adjustment value to the activator device via a network node or a sidelink connection.

The response signal may comprise transmit power information relating to the activation signal and the apparatus may be caused to perform providing an indication of the transmit power information relating to the activation signal to the activator device.

In a twelfth aspect there is provided a computer readable medium comprising instructions which, when executed by an apparatus, cause the apparatus to perform at least the following, at a tag device, receiving, at the tag device from an activator device, a configuration of a transmit power for a response signal from the tag device to at least one reader device and providing the response signal from the tag device to the at least one reader device at a transmit power determined based on the configuration.

The configuration of the transmit power may be included in an activation signal provided by the activator device to the tag device.

The response signal may comprise transmit power information relating to the activation signal.

In a thirteenth aspect there is provided a non-transitory computer readable medium comprising program instructions for causing an apparatus to perform at least the method according to the third or fourth aspect.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example 5GS communication system;

FIG. 2 shows a schematic diagram of an example mobile communication device;

FIG. 3 shows a schematic diagram of an example control apparatus;

FIG. 4 shows a flowchart of a method according to an example embodiment;

FIG. 5 shows a flowchart of a method according to an example embodiment;

FIG. 6 shows a flowchart of a method according to an example embodiment;

FIG. 7 shows a schematic diagram of an UE activator, UE reader, A-IoT device scenario;

FIG. 8 shows a signalling diagram according to an example embodiment;

FIG. 9 shows a schematic diagram of an UE activator, gNB reader, A-IoT device scenario;

FIG. 10 shows a signalling diagram according to an example embodiment.

### DETAILED DESCRIPTION

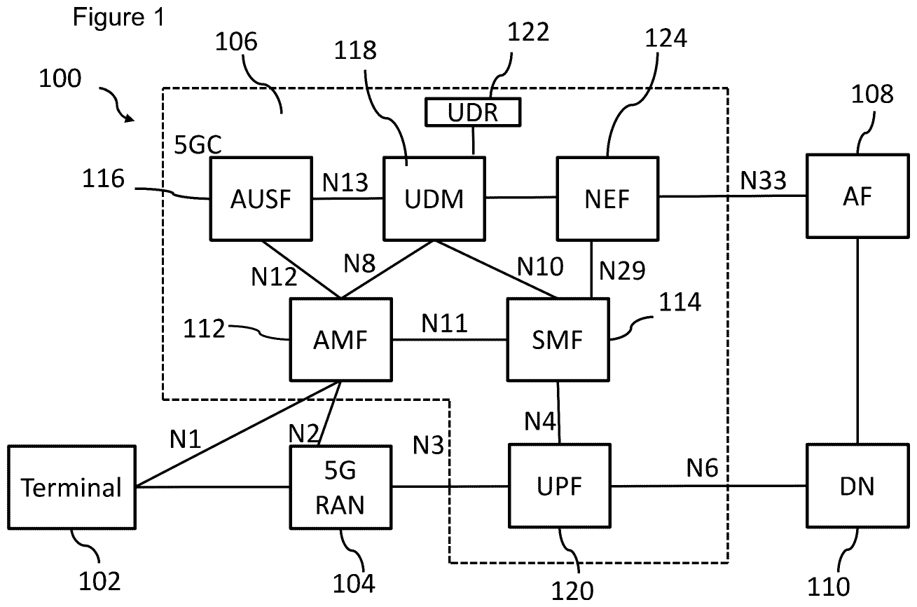

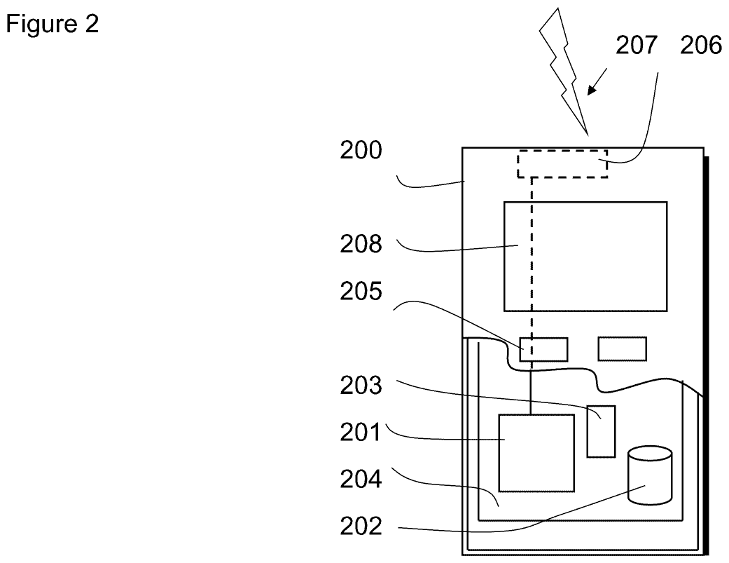

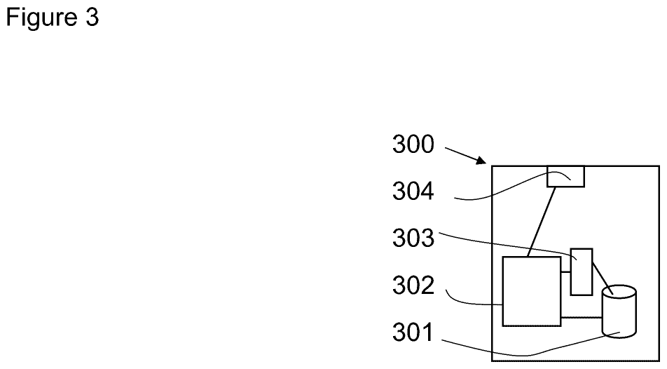

Before explaining in detail the examples, certain general principles of a wireless communication system and mobile communication devices are briefly explained with reference to FIG. 1, FIG. 2 and FIG. 3 to assist in understanding the technology underlying the described examples.

An example of a suitable communications system is the 5G or NR concept. Network architecture in NR may be similar to that of LTE-advanced. Base stations of NR systems may be known as next generation NodeBs (gNBs). Changes to the network architecture may depend on the need to support various radio technologies and finer Quality of Service (QOS) support, and some on-demand requirements for e.g. QoS levels to support Quality of Experience (QoE) for a user. Also network aware services and applications, and service and application aware networks may bring changes to the architecture. Those are related to Information Centric Network (ICN) and User-Centric Content Delivery Network (UC-CDN) approaches. NR may use Multiple Input—Multiple Output (MIMO) antennas, many more base stations or nodes than the LTE (a so-called small cell concept), including macro sites operating in co-operation with smaller stations and perhaps also employing a variety of radio technologies for better coverage and enhanced data rates.

Future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations and base station operations may differ from that of the LTE or even be non-existent.

FIG. 1 shows a schematic representation of a 5G system (5GS) 100. The 5GS may comprise a user equipment (UE) 102 (which may also be referred to as a communication device or a terminal), a 5G radio access network (5GRAN) 104, a 5G core network (5GCN) 106, one or more internal or external application functions (AF) 108 and one or more data networks (DN) 110.

An example 5G core network (CN) comprises functional entities. The 5GCN 106 may comprise one or more Access and mobility Management Functions (AMF) 112, one or more session management functions (SMF) 114, an authentication server function (AUSF) 116, a Unified Data Management (UDM) 118, one or more user plane functions (UPF) 120, a Unified Data Repository (UDR) 122 and/or a Network Exposure Function (NEF) 124. The UPF is controlled by the SMF (Session Management Function) that receives policies from a PCF (Policy Control Function).

The CN is connected to a UE via the Radio Access Network (RAN). The 5GRAN may comprise one or more gNodeB (gNB) Distributed Unit (DU) functions connected to one or more gNodeB (gNB) Centralized Unit (CU) functions. The RAN may comprise one or more access nodes.

A User Plane Function (UPF) referred to as PDU Session Anchor (PSA) may be responsible for forwarding frames back and forth between the DN and the tunnels established over the 5G towards the UE(s) exchanging traffic with the DN.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, voice over IP (VOIP) phones, portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), smart devices, wireless customer-premises equipment (CPE), or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts, and other information.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant components can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

FIG. 3 shows an example of a control apparatus 300 for a communication system, for example to be coupled to and/or for controlling a station of an access system, such as a RAN node, e.g. a base station, eNB or gNB, a relay node or a core network node such as an MME or Serving Gateway (S-GW) or Packet Data Network Gateway (P-GW), or a core network function such as AMF/SMF, or a server or host. The method may be implemented in a single control apparatus or across more than one control apparatus. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head.

The number of Internet of Things (IoT) connections has been growing rapidly in recent years and is predicted to be hundreds of billions by 2030. More and more ‘things’ are expected to be interconnected, e.g., to improve production efficiency or increase comforts of life, a further reduction of size, cost, and power consumption for IoT devices is sought. For example, regular replacement of battery for IoT devices is impractical due to their number and the resulting consumption of materials and manpower. It has become a trend to use energy harvested from environments to power IoT devices for self-sustainable communications, especially in applications with a huge number of devices (e.g., ID tags and sensors).

3GPP has specified NB-IoT/eMTC and NR RedCap before R18 to satisfy requirements on low cost and low power devices for wide area IoT communication. These IoT devices usually consume tens or hundreds of milliwatts power during transceiving, while the cost is a few dollars. However, to achieve the internet of everything, IoT devices with ten or even a hundred times lower cost and power consumption are sought, especially for a large number of applications requiring batteryless devices.

One issue with existing 3GPP technologies for target use cases is the capability of cooperating with energy harvesting considering limited device size. Taking a NB-IoT module as an example, a typical current consumption for receive processing is about 60 mA with supply voltage higher than 3.1V, while 70 mA for transmit processing at OdBm transmit power. The output power provided by a typical energy harvester is mostly below 1 milliwatt, considering the small size of a few square centimetres for practical devices. Since the available power is far less than the consumed power, it may be impractical to power cellular devices directly by energy harvesting.

One possible solution is to integrate energy harvesting with a rechargeable battery or supercapacitor. However, there are still a few problems to be solved. Firstly, both rechargeable battery and supercapacitor may suffer from shortened lifetime in practical cases. It is hard to provide constant charging current or voltage by energy harvesting, while longtime continuous charging is needed due to the small output power from an energy harvester. Inconstant charging current and longtime continuous charging are both harmful to battery life. For supercapacitor, its lifetime may be significantly reduced in high temperature environments (e.g., less than 3 years at 50 degrees centigrade). Secondly, device size will be significantly increased. As small size button battery can only provide current of a few tens of milliamps, a battery with much larger size (e.g., AA battery) is usually used to power cellular devices, whose size can be even larger than the module itself. To store energy for a proper duration of working (e.g., one second), the required capacitance of a supercapacitor is at the level of a hundred mill-farads. The size of such supercapacitors may be larger than an NB-IoT module. Thirdly, both rechargeable batteries and supercapacitors can be more expensive than the module itself. Even purchased in large quantities, the cost of a suitable battery or supercapacitor may reach one or a few dollars, which may double the cost of the device.

RFID is a well-known technology supporting battery less tags (also referred to as IoT devices). The power consumption of commercial passive RFID tags can be as low as 1 microwatt. The key techniques enabling such low power consumption are envelope detection for downlink data reception, and backscatter communication for uplink data transmission. RFID is designed for short-range communications, whose typical effective range is less than 10 meters. As the air interface of RFID is almost unchanged since 2005, the transmission scheme becomes an obstacle for improving link budget and its capability of supporting a scalable network.

Attracted by the extremely low power consumption of backscatter communication, many non-3GPP technologies begin to put efforts into related research, such as Wi-Fi, Bluetooth, UWB, and LoRa. Various research shows that a few or tens of microwatts power consumption can be supported for passive tags based on or with small modifications to the above air interfaces. A significant proportion of the studies are targeting at long range communication. Among them, a LoRa tag implemented with commercial off-the-shelf components can send its sensing data to the receiver of 381 meters away. Currently, most of the studies are focusing on independent detailed techniques for various optimization targets. It is hard to see a comprehensive system design fully meeting the requirements of the target use cases. However, the standardization of those technologies is agile and quick, as the industries usually follow some de facto standards. It means that many products in the market will follow even a private standard once it shows competitiveness in some applications.

A passive radio is a device that harnesses energy from wireless signals sent on specific carriers and/or bandwidths and charges a simple circuitry that, once activated, it will emit/reflect a signal which encodes at least the ID of the passive radio. The typical system architecture around a passive radio consists of an activator which is a device that sends an activation signal targeted at waking up the passive radio, the passive radio which harnesses energy over a range of frequencies and listens for activation signals (once such a signal is detected, the passive radio emits/reflects a signal which is specific to that radio ID) and a reader which is a device that listens and detects the passive radio signals. The reader may or may not be collocated with the activator.

3GPP is studying Ambient IoT and in RAN #98e & #99, it was agreed to focus on three device types, Device A, Device B and Device C.

Device A is a passive device with no energy storage. Device B is a passive device with energy storage and Device C is an active device with energy storage.

The design target for power consumption is less than or equal to 10 μW for Device A, less than or equal to 1 mW for Device C and between these values for Device B. The device complexity design target is comparable to UHF RFID for Device A, orders of magnitude lower than NB-IoT for Device C and between Device A and Device C for Device B.

An Ambient IoT (A-IoT) device type C may have active components enabling transmit power potentially of up to 24 dBm like normal handheld devices. While the device does have energy storage, the capacity and energy availability are limited by relying solely on energy harvesting. Consequently, one system design criterium is to keep the transmit power to a minimum required level. Furthermore, having Ambient IoT devices with high power (e.g., 24 dBm) capabilities introduces interference risks with high density deployment of these new Ambient IoT devices.

In NR devices (and earlier cellular standards), similar problems may be solved using uplink power control. However, for Ambient IoT relying on device triggers/activators and device readers, there are three entities, the A-IoT activator, the A-IoT device and the A-IoT reader(s), which do not all have bidirectional links to each other.

In other words, the entity that is tasked to request data from the A-IoT device (i.e., the activator) is not necessarily the same as the entity receiving the data (i.e., the reader). Therefore, if a reception failure occurs, the reader cannot correct the link immediately (as done in standard Uu communication), since it has no means of addressing the A-IoT device directly.

In 5G Power Control, also known as uplink power control, transmit power is increased to meet required SNR or BER at the gNB (or base station or eNB). Transmit power is decreased to minimize co-channel interference of the 5G system. There are two types of power controls, open loop power control and closed loop power control. The power control scheme is based on alignment between two nodes, e.g., gNB & UE or UE & UE (sidelink). For multi-static Ambient IoT, there are three nodes involved in a communication session, e.g., activator, reader, and A-IoT device. Thus, known power control schemes do not apply directly to Ambient IoT.

The problem addressed in the following is therefore how to optimize the transmit power from the Ambient IoT device type C while not introducing unnecessary interference and minimizing the Ambient IoT device power consumption.

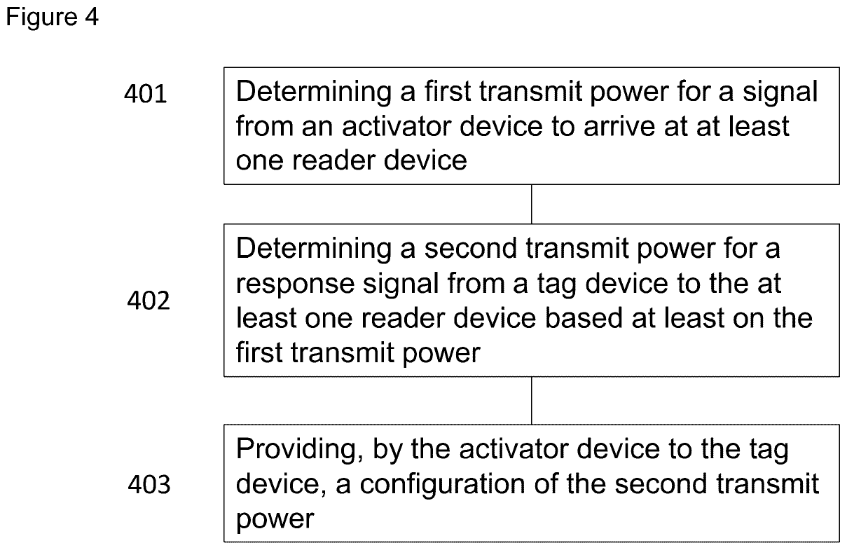

FIG. 4 shows a flowchart of a method according to an example embodiment. The method may be performed by an activator device (also referred to as an Activator).

In 401, the method comprises determining a first transmit power for a signal from the activator device to arrive at at least one reader device.

In 402, the method comprises determining a second transmit power for a response signal from a tag device to the at least one reader device based at least on the first transmit power.

In 403, the method comprises providing, by the activator device to the tag device, a configuration of the second transmit power.

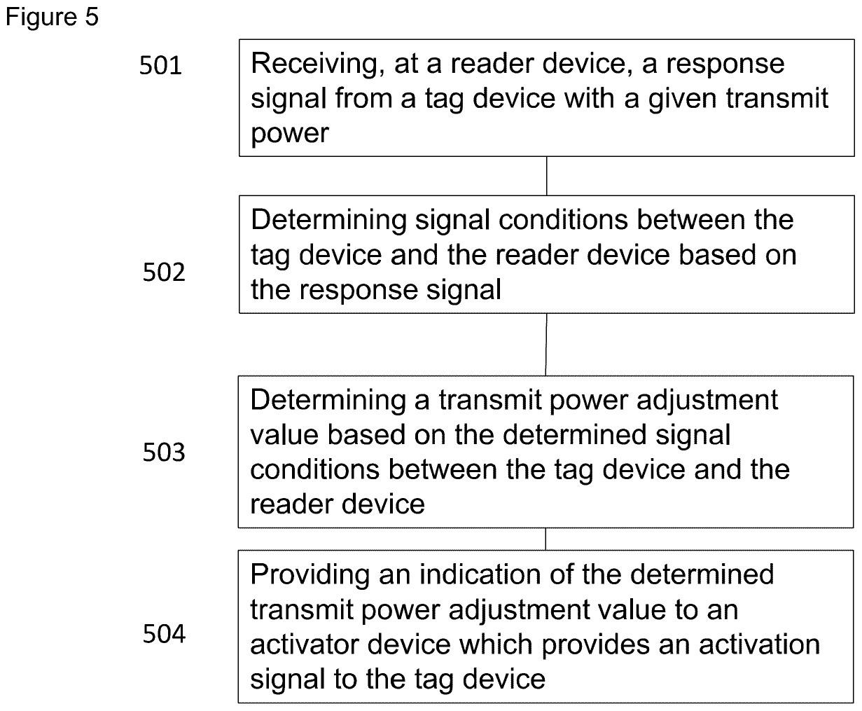

FIG. 5 shows a flowchart of a method according to an example embodiment. The method may be performed at a reader device (also referred to as a Reader).

In 501, the method comprises receiving, at a reader device, a response signal from a tag device with a given transmit power.

In 502, the method comprises determining signal conditions between the tag device and the reader device based on the response signal.

In 503, the method comprises determining a transmit power adjustment value based on the determined signal conditions between the tag device and the reader device.

In 504, the method comprises providing an indication of the determined transmit power adjustment value to an activator device which provides an activation signal to the tag device.

The given transmit power may be the second transmit power as described with reference to FIG. 4. The transmit power adjustment value may be applied to the second transmit power and referred to as a second transmit power adjustment value.

The activator device may provide an updated configuration of the tag transmit power (second transmit power) based on the adjustment value via the activation signal to the tag device.

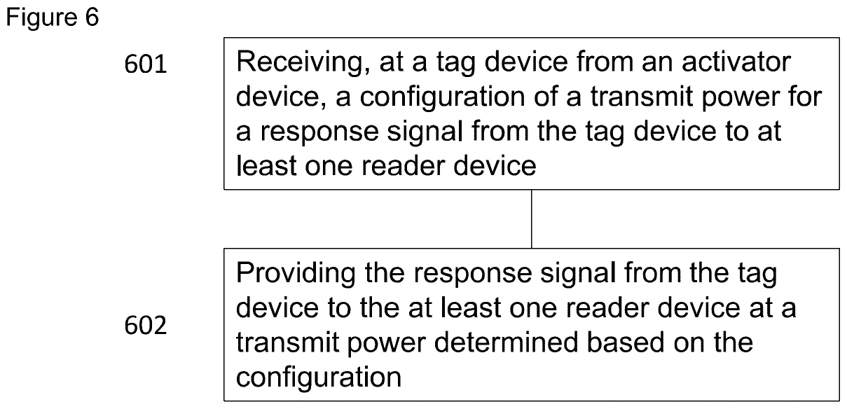

FIG. 6 shows a flowchart of a method according to an example embodiment. The method may be performed at a tag device, also referred to herein as in Ambient IoT device (A-IoT) or tag.

In 601, the method comprises receiving, at a tag device from an activator device, a configuration of a transmit power for a response signal from the tag device to at least one reader device.

In 602, the method comprises providing the response signal from the tag device to the at least one reader device at a transmit power determined based on the configuration.

The configuration of the transmit power may be a configuration of the second transmit power described with reference to FIG. 4. The transmit power at which the tag device provides the response signal is the second transmit power described with reference to FIG. 4.

The configuration of the second transmit power may be included in an activation signal provided by the activator device to the tag device at a third transmit power.

The second transmit power may be equal to the first transmit power. The first transmit power may be referred to as TX_A. The second transmit power may be referred to as AIoT_C transmit power (or response transmission power) or P_IoT_C ( ).

In an example embodiment, TX_A is used as baseline for the required AIoT_C transmit power, assuming AIoT_C is in proximity of UE_A for proper activation.

The at least one reader device may comprise a network node or a user equipment. The activator device may have reading capabilities (i.e. able to act as a reader device).

Determining the first transmit power may comprise performing an open loop power control procedure between the activator device and the at least one reader.

For example, open loop power control, where a reader device sends a reference signal (e.g. a SL CSI-RS for which the transmission power is known) to an activator device. The activator device can then apply channel inversion to determine a required transmission power (i.e., a first transmit power).

Alternatively, or in addition, determining the first transmit power may comprise performing a sidelink ranging procedure between the activator device and the at least one reader device.

For example, in SL ranging the distance between UE_A and UE_B is determined. Based on that determined distance, an adequate transmit power (i.e., the first transmit power) can be determined (with the knowledge of the channel between UE_A and UE_B).

Alternatively, or in addition, determining the first transmit power may be based on a position of the activator device and the at least one reader device. That is, if UE_A and UE_B positions in the examples above are known, the first transmit power (also referred to as TX_A) may be approximated without measurements.

The first transmit power may be determined further based on a reader signal to noise requirement difference between a link between the activator device and the reader device and a link between the tag device and the reader device.

In an example embodiment, TX_A may be compensated by potential UE_B reader SNR requirement delta receiving the AIoT_C response signal vs the UE_A SL signal.

Alternatively, or in addition, the first transmit power may be determined further based on antenna gain difference between a link between the activator device and the reader device and a link between the tag device and the reader device. In an example embodiment, TX_A may be compensated with any known antenna gain differences between UE_A and A-IoT Device C.

The compensated (e.g., based SNR/Antenna gain deltas) TX_A may be used as baseline (e.g., as the first transmit power) for setting the second transmit power for the tag. The second transmit power may be equal to the compensated TX_A.

The second transmit power may comprise the first transmit power (or the compensated first transit power) and an offset value. The offset value may be added to or subtracted from the first transmit power. The offset value may be referred to as P_tag_max.

The offset value may be determined based on an estimated pathloss between the activator device and the tag device. This is an example of approximating the link conditions between an activator device and an A-IoT device.

In an example embodiment, the AIoT_C transmission power, P_IoT_C ( ) may initially be set equal to TX_A or TX_A+/−P_tag_max, where P_tag_max is an estimate of the extra power required for the AIoT_C device to be heard at the UE_B reader knowing that the AIoT_C device is in proximity of the UE_A activator, and TX_A is the first transmit power (which may a compensated first transmit power).

The signal conditions between the tag device and the reader device determined by the reader device based on the tag device response signal may comprise at least one of the following: receive signal quality or signal to noise ratio. The indication of the determined second transmit power adjustment value may be provided by the reader device to the activator device via a network node or a sidelink connection. The second transmit power adjustment value may be referred to as P_delta ( ).

The second transmit power may be determined by the activator device further based on the second transmit power adjustment value.

The activation signal may be provided by the activator device to the tag device at a third transmit power (referred to as P_act ( ). The response signal provided from the tag device to the reader device may comprise transmit power information relating to the activation signal. The reader device may provide an indication of the transmit power information relating to the activation signal to the activator device. The activator device may update the third transmit power based on the transmit power information relating to the activation signal.

If the activator device has reading capability, a method as described with reference to FIG. 4 may comprise receiving the response signal at the activator device and updating the third transmit power based on the received response signal, e.g., on UE_A path loss and the minimum AIoT_C trigger level.

Updating the third transmit power may comprise adjusting P_act ( ) by an amount P_UE_A_delta.

The transmit power information relating to the activation signal may comprise an activation power margin indication as seen from the tag receiver side. For example, the tag device may measure the level of the received activation signal and reports the margin in dB to its activation trigger sensitivity level. If this margin is below a threshold the Activator device should increase third TX power level, if the margin is above a threshold the activator may reduce third TX power and still successfully activate the tag.

The A-IoT device has a trigger level sensitivity (i.e. the power level required to trigger/wake up the device). Knowing this A-IoT trigger level the Activator can estimate the maximum distance for successful Tag triggering for a given activation TX power (assuming line of sight between Activator and Tag device), and thereby estimate P_UE_A delta

In an example embodiment, activation signal power level, P_act ( ) is set to an initial value high enough for proper reception by the AIoT_C. The power level may initially be estimated based on AIoT_C RX SNR requirement and a distance estimate if known. Alternatively, UE_A may start at high TX power and adjust by an amount, P_UE_A_delta, over consecutive activations until activation fails or is reported close to failing by AIoT_C.

Methods described herein may provide a power control mechanism to regulate the TX power of an A-IoT device, where the key to the mechanism is assessing the link conditions between the activator and reader, approximating the link conditions between the activator and the A-IoT device and combining information to set a TX power for the link between the reader and the A-IoT device, so that the reader may successfully decode the data from the A-IoT device.

This may minimize the cell interference by minimizing power levels for both AIoT device response and activator transmissions and it optimizes the AIoT device power consumption by avoiding the need to initially transmit responses at maximum power to ensure proper reader reception.

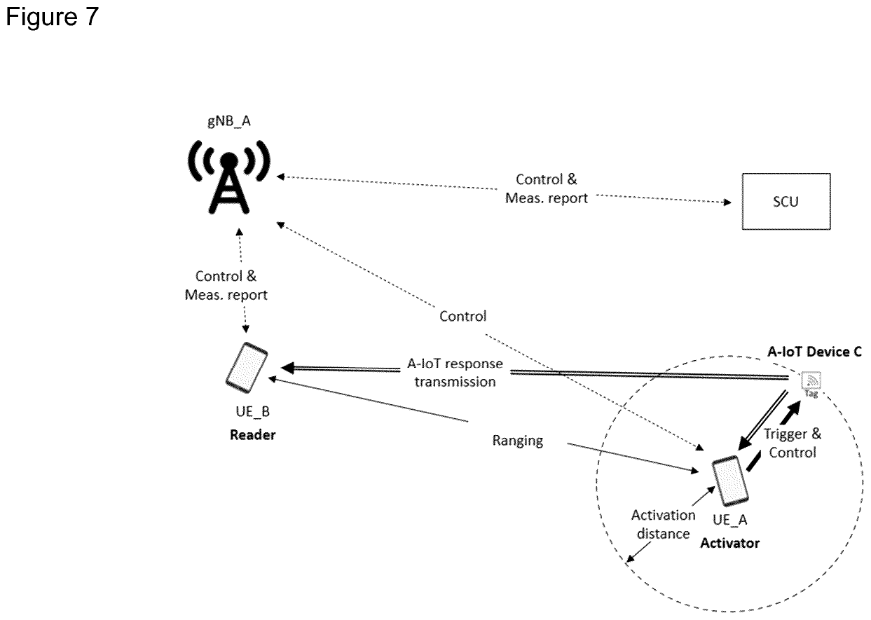

FIG. 7 shows an example scenario where the tag device is an A-IoT device C being activated by activator device UE_A and the transmitted response signal from the A-IoT device C is captured by a reader device UE_B. UE_A and UE_B send and receive control messages from a session control unit (SCU) via a gNB. UE_B sends measurement reports to the SCU via the gNB.

In the example scenario shown in FIG. 7, UE_A performs a SL ranging procedure with UE_B.

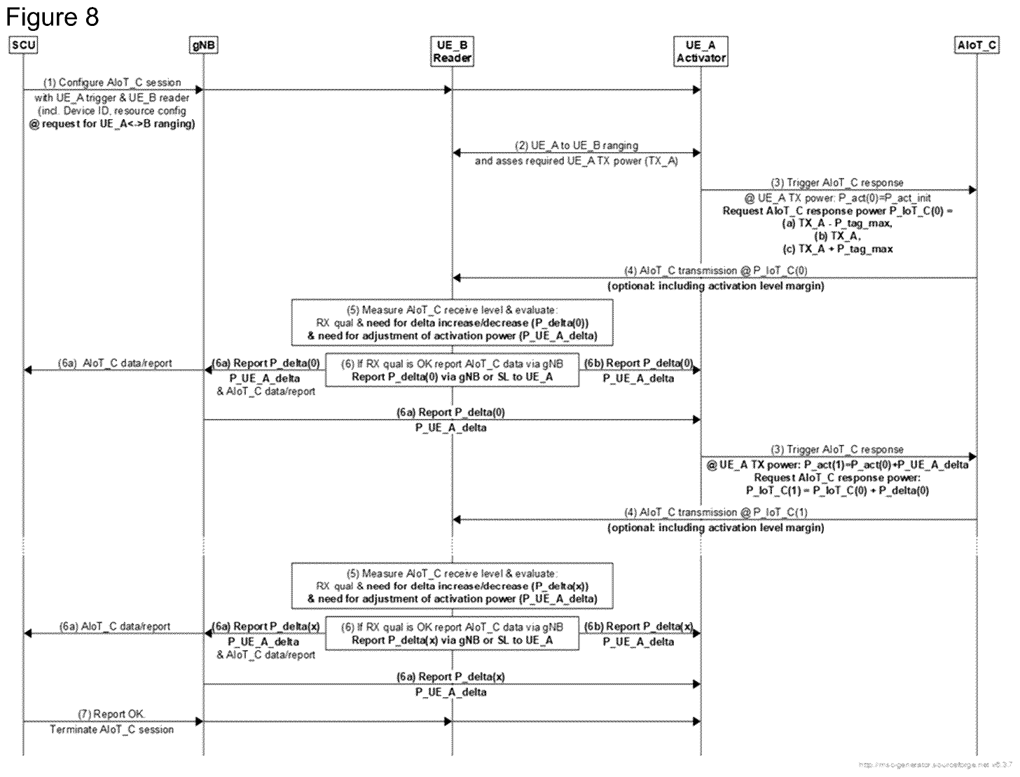

FIG. 8 shows a flow diagram of an example Ambient IoT device type C power control procedure in an example scenario such as that of FIG. 7.

In step 1, the SCU selects the trigger/activator device UE_A, the reader device, UE_B, and configures the A-IoT Device C session including A-IoT device C ID and resource configurations, e.g., which time-frequency-code resources the device is using.

In step 2, UE_A determines the required UE_A (Activator) transmission power (TX_A) for the activation signal required for (Reader) detection and decoding. TX_A is used as a baseline for setting the A-IoT_C response signal transmit power knowing that the AIoT_C device is in proximity of the Activator UE_A. This is an example of determining a first transmit power for a signal from the activator device to arrive at at least one reader device.

In step 3, UE_A activates AIoT_C by sending a trigger signal at transmit power P_act ( ) to AIoT_C including the AIoT_C ID and configuration of AIoT_C response transmission power level, P_IoT_C ( ) This is an example of providing, by the activator device to the tag device, a configuration of the second transmit power, wherein the configuration of the second transmit power is included in an activation signal provided by the activator device to the tag device at a third transmit power.

In step 4, AIoT_C, transmits towards the UE_B reader at power level P_IoT_C ( ) optionally including activation power level margin indication. The activation power level margin indication is an example of transmit power information relating to the activation signal.

In step 5, UE_B receives the AIoT_C transmission and evaluates RX quality & SNR and confirms the need for AIoT_C transmission power adjustment, P_delta ( ) This is an example of receiving, at a reader device, a response signal from a tag device with a given transmit power, determining signal conditions between the tag device and the reader device based on the response signal and determining a transmit power adjustment value based on the determined signal conditions between the tag device and the reader device. If the response signal includes the activation power level margin, P_UE_A delta may also be determined. P_UE_A_delta may comprise the tag reported activation power level margin.

In step 6, UE_B provides status and received AIoT_C data to the SCU. UE_B also reports P_delta ( ) to UE_A directly via SL or via gNB in step 6. This is an example of providing the indication of the determined transmit power adjustment value to the activator device via a network node or a sidelink connection. UE_B may also report P_UE_A delta to UE_A via SL or via a network node and UE_A can use P_UE_A delta as third transmit power adjustment factor.

In step 7, SCU issues IoT_C session termination based on receiving successful session results report.

Steps 3-6 may be repeated to settle on minimum viable UE_A activation power level and minimum viable AIoT_C transmission power level thereby minimizing power consumption and cell interference.

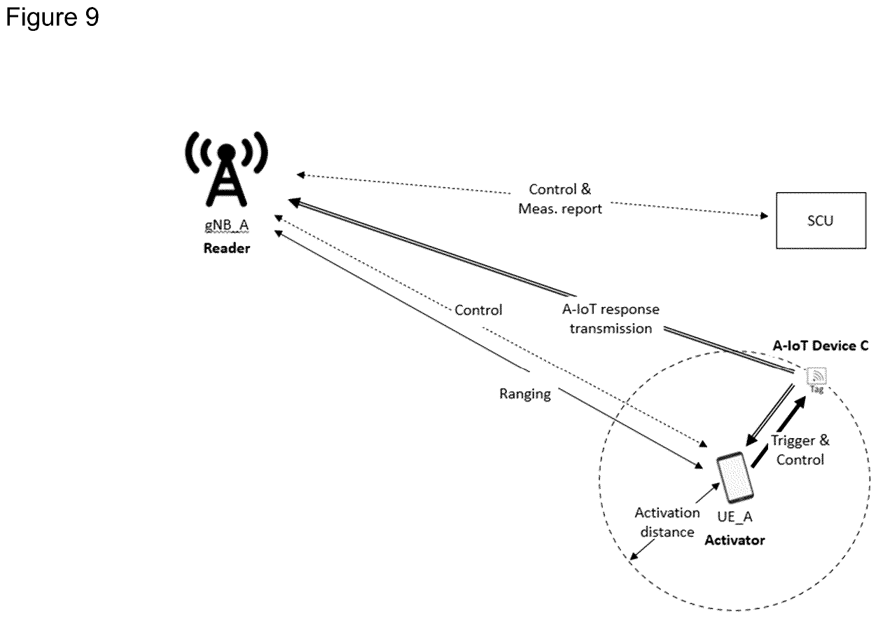

FIG. 9 shows an example embodiment, where the at least one reader device comprises a network node (gNB in the example embodiment shown in FIG. 9).

In this setting there are two cases:
(i). The A-IoT Device C is unable to listen to the gNB DL signals and therefore is unable to perform open loop power control;
(ii). The A-IoT Device C is able to listen to the gNB DL signals (e.g. SSB) and therefore is able to apply open loop power control;

In the first case (i), the activator provides the absolute transmission power to be used by the A-IoT Device C to perform its transmission. While in the second case (ii), the activator device provides a delta power offset to be applied by the A-IoT Device C on top of the transmission power derived based on the open loop power control using the gNB DL signals.

With reference to the scenario depicted in FIG. 7 used for positioning of the A-IoT device ranging towards multiple readers is required. In this case, if the activating UE_A has reading capability as well, the following procedure will enable transmission power control for both the Activator device and the A-IoT device without a need for tag activation level margin reporting since the Activator device can now directly measure and evaluate P_UE_A_delta.

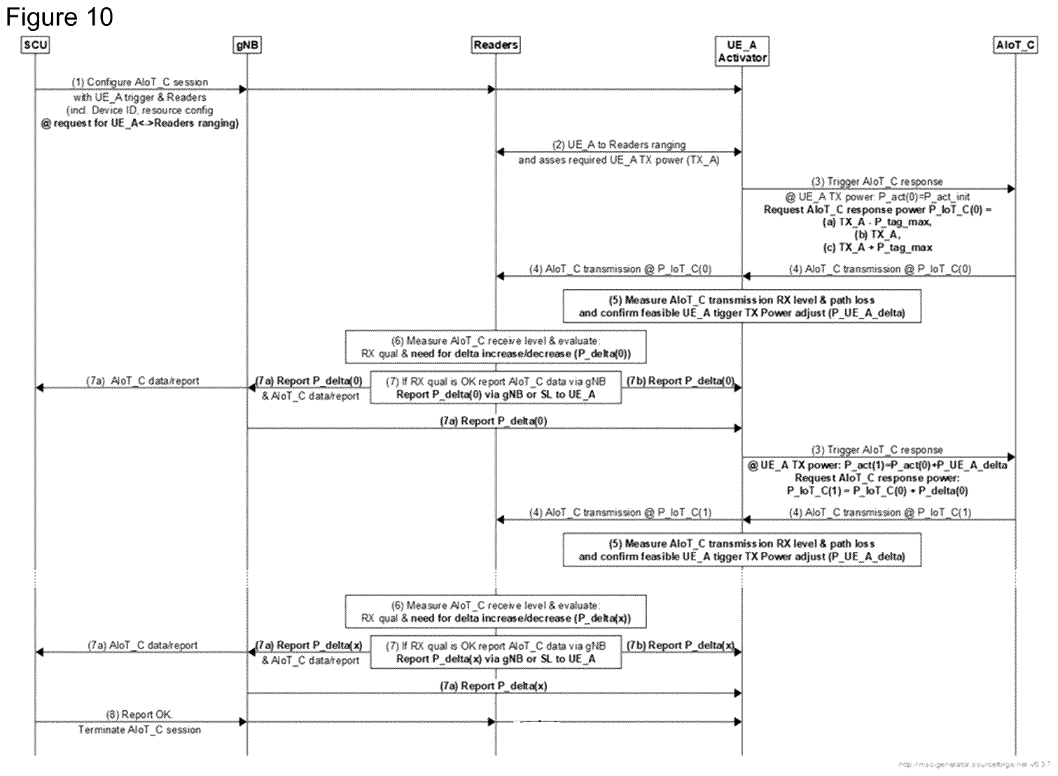

FIG. 10 shows a flowchart of a method where there is a plurality of readers and the UE_A has reading capability. In FIG. 10, the at least one reader device comprises a network node but the at least one reader device may also comprise a UE and at least one reader device may comprise the activator device (that is, the activator device has reading capabilities).

Steps 1 to 4 are as described with reference to FIG. 8, but with a plurality of readers replacing UE_B.

In step 5, UE_A measures the received level of the AIoT_C transmission and confirms feasible activator transmit power adjustment, P_UE_A_delta, based on the AIoT_C to UE_A path loss and the minimum AIoT_C trigger level.

In this example embodiment, AIoT_C is actively transmitting so may be configured for responding shifted in time compared to the UE_A activation. UE_A may receive the AIoT_C signal without need for full duplex capability acting as additional reader beneficial for positioning which may enable accurate activator power control.

In step 6, the readers receive the AIoT-C transmission and evaluates RX quality & SNR and confirms the need for AIoT_C transmission power adjustment, P_delta ( ) This is an example of receiving, at a reader device, a response signal from a tag device with a given transmit power, determining signal conditions between the tag device and the reader device based on the response signal and determining a transmit power adjustment value based on the determined signal conditions between the tag device and the reader device.

In step 7, the readers provide status and received AIoT_C data to the SCU and reports P_delta ( ) to UE_A directly via SL or via gNB.

In step 8, the SCU issues IoT_C session termination based on receiving successful session results report.

Steps 3-7 may be repeated to settle on minimum viable UE_A trigger power level and minimum viable AIoT_C transmission power level thereby minimizing power consumption and cell interference.

An apparatus may comprise means for determining a first transmit power for a signal from the activator device to arrive at at least one reader device, determining a second transmit power for a response signal from a tag device to the at least one reader device based at least on the first transmit power and providing, by the activator device to the tag device, a configuration of the second transmit power for the response signal from the tag device to the at least one reader device.

Alternatively, or in addition, an apparatus may comprise means for receiving, at the reader device, a response signal from a tag device with a given transmit power, determining signal conditions between the tag device and the reader device based on the response signal, determining a transmit power adjustment value based on signal conditions between a tag device and the reader device and providing an indication of the determined transmit power adjustment value to an activator device which provides an activation signal to the tag device.

Alternatively, or in addition, an apparatus may comprise means for receiving, at the tag device from an activator device, a configuration of a transmit power for a response signal from the tag device to at least one reader device and providing the response signal from the tag device to the at least one reader device at a transmit power determined based on the configuration.

The apparatus may comprise a device, be the device or be comprised in the device or a chipset for performing at least some actions of/for the device.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst some embodiments have been described in relation to 5G networks, similar principles can be applied in relation to other networks and communication systems such as 6G networks or 5G-Advanced networks. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

As used herein, “at least one of the following: <a list of two or more elements>” and “at least one of <a list of two or more elements>” and similar wording, where the list of two or more elements are joined by “and” or “or”, mean at least any one of the elements, or at least any two or more of the elements, or at least all the elements.

In general, the various embodiments may be implemented in hardware or special purpose circuitry, software, logic or any combination thereof. Some aspects of the disclosure may be implemented in hardware, while other aspects may be implemented in firmware or software which may be executed by a controller, microprocessor or other computing device, although the disclosure is not limited thereto. While various aspects of the disclosure may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

As used in this application, the term “circuitry” may refer to one or more or all of the following:
(a) hardware-only circuit implementations (such as implementations in only analog and/or digital circuitry) and
(b) combinations of hardware circuits and software, such as (as applicable):
   (i) a combination of analog and/or digital hardware circuit(s) with software/firmware and
   (ii) any portions of hardware processor(s) with software (including digital signal processor(s)), software, and memory(ies) that work together to cause an apparatus, such as a mobile phone or server, to perform various functions) and
      I hardware circuit(s) and or processor(s), such as a microprocessor(s) or a portion of a microprocessor(s), that requires software (e.g., firmware) for operation, but the software may not be present when it is not needed for operation.”

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

The embodiments of this disclosure may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media. The term “non-transitory,” as used herein, is a limitation of the medium itself (i.e., tangible, not a signal) as opposed to a limitation on data storage persistency (e.g., RAM vs. ROM).

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the disclosure may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The scope of protection sought for various embodiments of the disclosure is set out by the independent claims. The embodiments and features, if any, described in this specification that do not fall under the scope of the independent claims are to be interpreted as examples useful for understanding various embodiments of the disclosure.

The foregoing description has provided by way of non-limiting examples a full and informative description of the exemplary embodiment of this disclosure. However, various modifications and adaptations may become apparent to those skilled in the relevant arts in view of the foregoing description, when read in conjunction with the accompanying drawings and the appended claims. However, all such and similar modifications of the teachings of this disclosure will still fall within the scope of this invention as defined in the appended claims. Indeed, there is a further embodiment comprising a combination of one or more embodiments with any of the other embodiments previously discussed.

1. (canceled)

2. The apparatus according to claim 1, wherein
the configuration of the second transmit power is included in an activation signal provided by the activator device to the tag device at a third transmit power.

3. The apparatus according to claim 2, wherein the apparatus is caused to receive an indication of transmit power information relating to the activation signal and update the third transmit power based on the transmit power information relating to the activation signal.

4. The apparatus according to claim 2, comprising means for receiving wherein the apparatus is caused to receive the response signal at the activator device and update the third transmit power based on the received response signal.

5. The apparatus according to claim 1, wherein determining the first transmit power comprises performing an open loop power control procedure between the activator device and the at least one reader device or performing a sidelink ranging procedure between the activator device and the at least one reader device or is based on a position of the activator device and the at least one reader device.

6. The apparatus according to claim 5, wherein the first transmit power is further determined based on at least one of the following: a reader signal to noise requirement difference or an antenna gain difference between a link between the activator device and the reader device and a link between the tag device and the reader device.

7. The apparatus according to claim 1, wherein the second transmit power is equal to the first transmit power.

8. The apparatus according to claim 1, wherein the second transmit power comprises the first transmit power and an offset value.

9. The apparatus according to claim 8, wherein the offset value is determined based on an estimated pathloss between the activator device and the tag device.

10. The apparatus according to claim 1, wherein the at least one reader device comprises a network node.

11. The apparatus according to claim 1, wherein the apparatus is caused to receive an indication from the at least one reader device of a transmit power adjustment value; and wherein determining the second transmit power is further based on the transmit power adjustment value.

12. The apparatus according to claim 11, wherein the apparatus is caused to receive the indication of the transmit power adjustment value via a network node or a sidelink connection.

13. (canceled)

14. The apparatus according to claim 13, wherein the signal conditions comprise at least one of the following: receive signal quality or signal to noise ratio.

15. The apparatus according to claim 13, wherein the apparatus is caused to provide the indication of the determined transmit power adjustment value to the activator device via a network node or a sidelink connection.

16. The apparatus according to claim 13, wherein the response signal comprises transmit power information relating to the activation signal and causes the apparatus to provide an indication of the transmit power information relating to the activation signal to the activator device.

17. (canceled)

18. The apparatus according to claim 17, wherein the configuration of the transmit power is included in an activation signal provided by the activator device to the tag device.

19. The apparatus according to claim 18, wherein the response signal comprises transmit power information relating to the activation signal.

20-22. (canceled)

23. An apparatus comprising:
at least one processor, and at least one memory including computer program code, wherein the at least one memory and the computer program code are configured, with the at least one processor, to cause the apparatus at least to, at an activator device:
determine a first transmit power for a signal from the activator device to arrive at at least one reader device;
determine a second transmit power for a response signal from a tag device to the at least one reader device based at least on the first transmit power; and
provide, by the activator device to the tag device, a configuration of the second transmit power.

24. An apparatus comprising:
at least one processor, and at least one memory including computer program code, wherein the at least one memory and the computer program code are configured, with the at least one processor, to cause the apparatus at least to, at a reader device:
receive, at the reader device, a response signal from a tag device with a given transmit power;
determine signal conditions between the tag device and the reader device based on the response signal;
determine a transmit power adjustment value based on the determined signal conditions between the tag device and the reader device; and
provide an indication of the determined transmit power adjustment value to an activator device which provides an activation signal to the tag device.

25. An apparatus comprising:
at least one processor, and at least one memory including computer program code, wherein the at least one memory and the computer program code are configured, with the at least one processor, to cause the apparatus at least to, at a tag device:
receive, at the tag device from an activator device, a configuration of a transmit power for a response signal from the tag device to at least one reader device; and
provide the response signal from the tag device to the at least one reader device at a transmit power determined based on the configuration.
